(19) United States
(12) Patent Application Publication
(10) Pub. No.: US 2017/0368985 A1
(43) Pub. Date: Dec. 28, 2017

(54) VEHICLE PROJECTION DEVICE

(71) Applicant: KABUSHIKI KAISHA TOKAI-RIKA-DENKI-SEISAKUSHO, Aichi (JP)

(72) Inventors: Kazuyuki YOKOYAMA, Aichi (JP); Masatsugu OHASHI, Aichi (JP); Masahiro ARAI, Aichi (JP)

(21) Appl. No.: 15/543,495

(22) PCT Filed: Dec. 17, 2015
(86) PCT No.: PCT/JP2015/085404

§ 371 Date: Jul. 13, 2017

(30) Foreign Application Priority Data
Jan. 20, 2015 (JP) 2015-008820

(51) Int. Cl. B60Q 1/26; G03B 21/14; G03B 21/16; G03B 29/00; G03B 21/64

(52) U.S. Cl. CPC B60Q 1/26; G03B 29/00; G03B 21/64; G03B 21/16; G03B 21/145; B60Q 2400/50; B60Q 1/2665

(57) ABSTRACT

A vehicle projection device projects a graphic of a film body housed in a housing toward an outer side of the housing. It is possible to detach the film body toward an exterior of the housing via a communication hole in the housing by gripping a grip portion of the film body. This thereby enables the film body to be detached toward the exterior of the housing.

### TECHNICAL FIELD

The present invention relates to a vehicle projection device that projects an image.

### BACKGROUND ART

In a graphic projection lamp described in the specification of Chinese Utility Model Application No. 202382141, a graphic film is disposed inside an lamp outer shell, and a graphic on the graphic film is projected toward an outer side of the lamp outer shell.

In such a graphic projection lamp, it is preferable for the image film to be detachable toward an exterior of the lamp outer shell.

### SUMMARY OF INVENTION

### Technical Problem

In consideration of the above circumstances, an object of the present invention is to obtain a vehicle projection device in which an image member can be detached toward an exterior of a housing body.

### Solution to Problem

A vehicle projection device of a first aspect of the present invention includes a housing body, an image member, and a projection means. The housing body is provided at a vehicle and includes a detachment section. The image member is disposed inside the housing body, includes an image, and is capable of being detached toward an exterior of the housing body via the detachment section. The projection means projects the image toward an outer side of the housing body.

A vehicle projection device of a second aspect of the present invention is the vehicle projection device of the first aspect of the present invention, further including a restriction means that restricts incursion of water into the housing body via the detachment section.

A vehicle projection device of a third aspect of the present invention is the vehicle projection device of either the first aspect or the second aspect of the present invention, further including an anchor means that anchors the image member inside the housing body.

A vehicle projection device of a fourth aspect of the present invention is the vehicle projection device of any one of the first aspect to the third aspect of the present invention, further including a supply body and a connector. The supply body configures the projection means and is disposed such that the detachment section is on one side of the supply body. The connector is disposed inside the housing body via the detachment section, is disposed on the one side of the supply body, is connected to the supply body, and supplies electric power to the supply body.

### Advantageous Effects of Invention

In the vehicle projection device of the first aspect of the present invention, the image member is disposed inside the housing body provided at the vehicle, and the projection means projects the image provided at the image member toward the outer side of the housing body.

The housing body includes the detachment section, and the image member can be detached toward the exterior of the housing body via the detachment section. This thereby enables the image member to be detached toward the exterior of the housing body.

In the vehicle projection device of the second aspect of the present invention, the restriction means restricts incursion of water into the housing body via the detachment section. This thereby enables incursion of water into the housing body to be suppressed.

In the vehicle projection device of the third aspect of the present invention, the anchor means anchors the image member inside the housing body. This thereby enables unintended removal of the image member toward the exterior of the housing body to be suppressed.

In the vehicle projection device of the fourth aspect of the present invention, the supply body configures the projection means. The connector is connected to the supply body, and supplies electric power to the supply body.

The detachment section is disposed on the one side of the supply body, and the connector is disposed inside the housing body via the detachment section, and is disposed on the one side of the supply body. Accordingly, the size of the vehicle projection device at the other side of the supply body can be reduced, unlike in cases in which the connector is disposed on the other side of the supply body.

### BRIEF DESCRIPTION OF DRAWINGS

FIG. 1 is a face-on view illustrating a vehicle door mirror device of a first exemplary embodiment of the present invention, as viewed from the vehicle rear.

FIG. 2 is a perspective view illustrating the vehicle projection device according to the first exemplary embodiment of the present invention, as viewed diagonally from the rear right of the vehicle.

FIG. 3 is a side view illustrating the vehicle projection device according to the first exemplary embodiment of the present invention, as viewed from the right of the vehicle.

FIG. 4 is a plan view illustrating the vehicle projection device according to the first exemplary embodiment of the present invention, as viewed from above.

FIG. 5 is a cross-section (a cross-section taken along line 5-5 in FIG. 4) illustrating the vehicle projection device according to the first exemplary embodiment of the present invention, as viewed from the right of the vehicle.

FIG. 6 is a perspective view illustrating an anchor claw of a film body in the vehicle projection device according to the first exemplary embodiment of the present invention, as viewed diagonally from the rear right of the vehicle.

FIG. 7A is a cross-section (a cross-section taken at the position of line 5-5 in FIG. 4), illustrating relevant portions of a first modified example of the vehicle projection device according to the first exemplary embodiment of the present invention, as viewed from the right of the vehicle.

FIG. 7B is a cross-section (a cross-section taken at the position of line 5-5 in FIG. 4), illustrating relevant portions of a second modified example of the vehicle projection device according to the first exemplary embodiment of the present invention, as viewed from the right of the vehicle.

FIG. 8 is a perspective view illustrating a vehicle projection device according to a second exemplary embodiment of the present invention, as viewed diagonally from the rear right of the vehicle.

FIG. 9 is a face-on view illustrating the vehicle projection device according to the second exemplary embodiment of the present invention, as viewed from the vehicle rear.

FIG. 10 is a bottom view illustrating the vehicle projection device according to the second exemplary embodiment of the present invention, as viewed from below.

FIG. 11 is a cross-section (a cross-section along line 11-11 in FIG. 10) illustrating the vehicle projection device according to the second exemplary embodiment of the present invention, as viewed from the vehicle front.

### DESCRIPTION OF EMBODIMENTS

### First Exemplary Embodiment

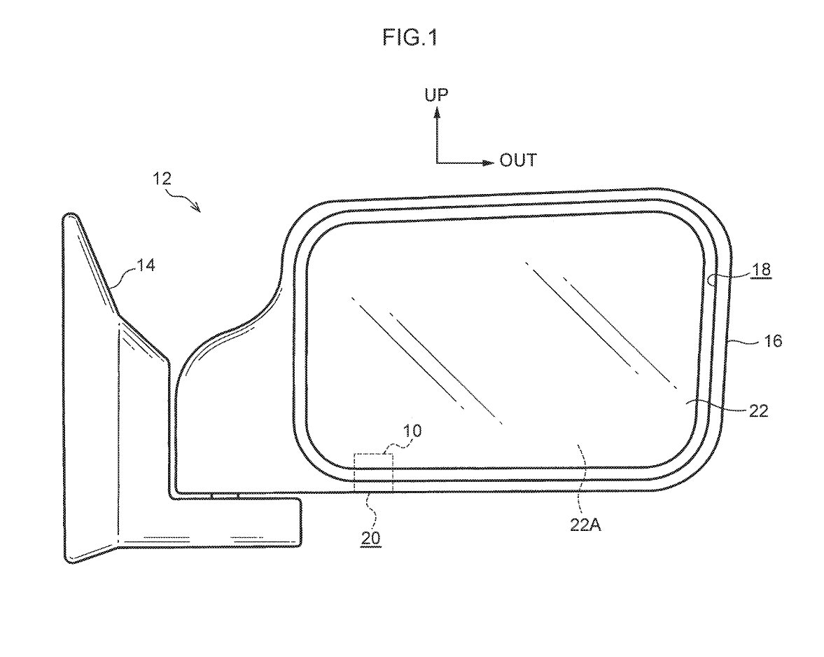

FIG. 1 is a face-on view illustrating a vehicle door mirror device 12, serving as an installation body installed with a vehicle projection device 10 according to a first exemplary embodiment of the present invention, as viewed from the vehicle rear. Note that in the drawings, the arrow FR indicates a vehicle front direction, the arrow OUT indicates the vehicle width direction outside (vehicle right), and the arrow UP indicates upwards.

The vehicle door mirror device 12 of the present exemplary embodiment is provided at a vehicle outside of an up-down direction intermediate portion and vehicle front side end of a side door (specifically, a front side door), serving as a vehicle door.

As illustrated in FIG. 1, the vehicle door mirror device 12 includes a stay 14, serving as a fixing member. A vehicle width direction inside end of the stay 14 is fixed to the side door (vehicle body side), thereby fixing the vehicle door mirror device 12 to the side door.

A substantially rectangular container-shaped visor 16, serving as an installation member, is supported on a vehicle width direction outside portion of the stay 14. The visor 16 is disposed at the vehicle width direction outside of the stay 14. A substantially rectangular shaped opening 18 is formed penetrating a vehicle rear side wall of the visor 16, and the opening 18 is open toward the vehicle rear side at the inside of the visor 16. A substantially rectangular shaped through hole 20 is formed penetrating a lower wall of the visor 16. The through hole 20 is open toward the lower side at the inside of the visor 16.

An attachment mechanism (not illustrated in the drawings) is fixed inside the visor 16, and a substantially rectangular plate shaped mirror 22, serving as a visual recognition means, is attached to the attachment mechanism. The mirror 22 is disposed inside the visor 16, in the vicinity of the opening 18. The mirror 22 substantially closes off the opening 18. A mirror surface 22A of the mirror 22 faces toward the vehicle rear side, such that the mirror 22 enables visual recognition rearward of the vehicle by an occupant of the vehicle (in particular, the driver), thus assisting the occupant with visual recognition. Moreover, the mirror 22 can be detached from the attachment mechanism. The interior of the visor 16 is open toward the vehicle rear side through the opening 18 when the mirror 22 has been detached from the attachment mechanism.

A vehicle projection device 10 is housed inside the visor 16, at an upper side of the through hole 20.

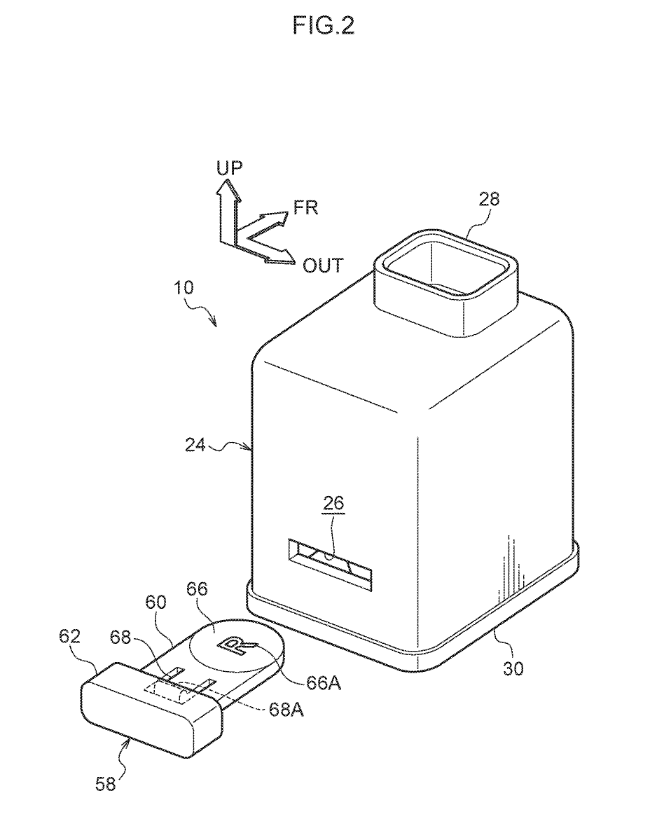

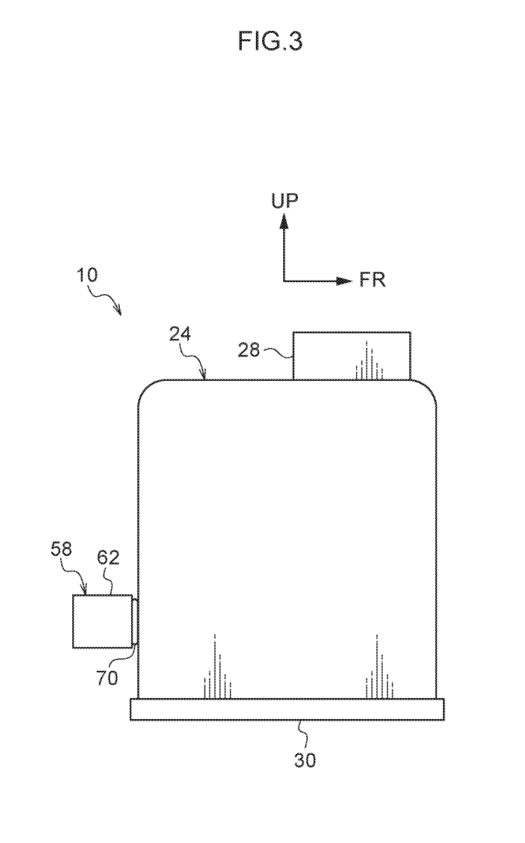

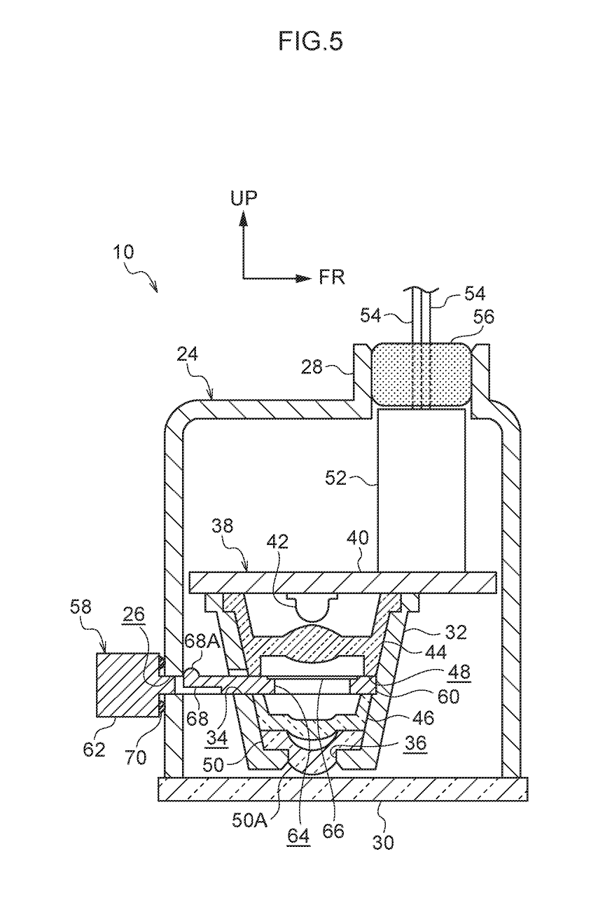

As illustrated in FIG. 2 to FIG. 5, the vehicle projection device 10 is provided with a substantially rectangular container-shaped housing 24, serving as a housing body (exterior member). The housing 24 is open at a lower face. The housing 24 is fixed inside the visor 16, thereby installing the vehicle projection device 10 inside the visor 16.

An elongated rectangular shaped communication hole 26, serving as a detachment section, is formed penetrating a lower portion of a vehicle rear side wall of the housing 24. The communication hole 26 extends in the vehicle width direction. A rectangular tube shaped connection tube 28 is integrally formed to an outer side of an upper wall of the housing 24. The interior of the connection tube 28 is in communication with the interior of the housing 24.

A rectangular plate shaped outer lens 30, serving as an exposure member, is fixed to a lower side of the housing 24. The outer lens 30 closes off the opening in the lower face of the housing 24. A seal is formed between the housing 24 and the outer lens 30, thereby restricting the incursion of water into the housing 24 from between the housing 24 and the outer lens 30. The outer lens 30 is disposed inside the through hole 20 of the visor 16, such that the outer lens 30 closes off the through hole 20.

A case 32, in the shape of an inverted circular frustum-shaped container and serving as an interior member, is fixed inside the housing 24. The case 32 is open at an upper face, and light cannot pass through the case 32. An elongated rectangular shaped opening 34, serving as an inner detachment section, is formed penetrating a vehicle rear side portion of a peripheral wall of the case 32. The opening 34 extends in a peripheral direction of the case 32, and faces the communication hole 26 in the housing 24 along the vehicle front-rear direction. A circular exposure hole 36 is formed penetrating a lower wall of the case 32. The exposure hole 36 is disposed coaxially to the case 32.

A projection mechanism 38, serving as a projection means, is provided at the case 32.

The projection mechanism 38 is provided with a rectangular plate shaped circuit board 40, serving as a supply body. The circuit board 40 is fixed to an upper side of the case 32.

An LED 42, serving as a light source, is fixed to a lower face of the circuit board 40. The LED 42 is electrically connected to the circuit board 40. The LED 42 is housed inside an upper end of the case 32, and the LED 42 is disposed on an axial center line of the case 32.

A collimator lens 44 that has a substantially H-shaped cross-section profile and that serves as a first lens is coaxially housed inside an upper-side portion of the case 32. The collimator lens 44 is fixed inside the case 32.

A first image-forming lens 46 that has a substantially U-shaped cross-section profile and that serves as a second lens is coaxially housed inside a lower-side portion of the case 32. The first image-forming lens 46 is fixed inside the case 32. A gap 48 is formed between the collimator lens 44 and the first image-forming lens 46. The gap 48 faces the opening 34 in the case 32 along the vehicle front-rear direction.

At a lower side of the first image-forming lens 46, a second image-forming lens 50 that has a substantially T-shaped cross-section profile and that serves as a third lens is coaxially housed inside the lower-side portion of the case 32. The second image-forming lens 50 is fixed inside the case 32. A substantially circular column shaped protrusion portion 50A is coaxially formed to the second image-forming lens 50. The protrusion portion 50A protrudes out toward the lower side, and is fitted into the exposure hole 36 in the case 32.

A rectangular column shaped connector 52 is attached to an upper side of the circuit board 40. The connector 52 is electrically connected to the circuit board 40. Cords 54 are electrically connected to the connector 52. The cords 54 are laid out toward the exterior of the housing 24 via the interior of the connection tube 28 of the housing 24, and are electrically connected to a power source (not illustrated in the drawings).

A grommet 56, serving as a sealing member, is fitted inside the connection tube 28 of the housing 24. The cords 54 pass through the grommet 56. The grommet 56 is elastic and has sealing properties. The grommet 56 is elastically compressed so as to form a seal inside the connection tube 28. This thereby restricts the incursion of water into the housing 24 from the exterior of the housing 24 via the interior of the connection tube 28.

A film body 58, serving as an image member, is attached inside the housing 24 and inside the case 32.

The film body 58 is provided with a substantially rectangular plate shaped insertion plate 60. A rectangular column shaped grip portion 62 is integrally formed to a vehicle rear side end of the insertion plate 60. The insertion plate 60 is inserted into the housing 24 via the communication hole 26 in the housing 24, and is fitted into the gap 48 inside the case 32 via the opening 34 in the case 32. The grip portion 62 is disposed at the exterior of the housing 24.

A circular transmitting hole 64 is formed penetrating a vehicle front side portion of the insertion plate 60. The transmitting hole 64 is disposed coaxially inside the case 32. A sheet-shaped graphic film 66 is fixed at an upper side of the insertion plate 60. The graphic film 66 is disposed at an upper side of the transmitting hole 64. A graphic 66A (for example, a symbol), serving as an image, is provided at the graphic film 66 at a location at an upper side of the transmitting hole 64. Light is able to pass through the graphic film 66.

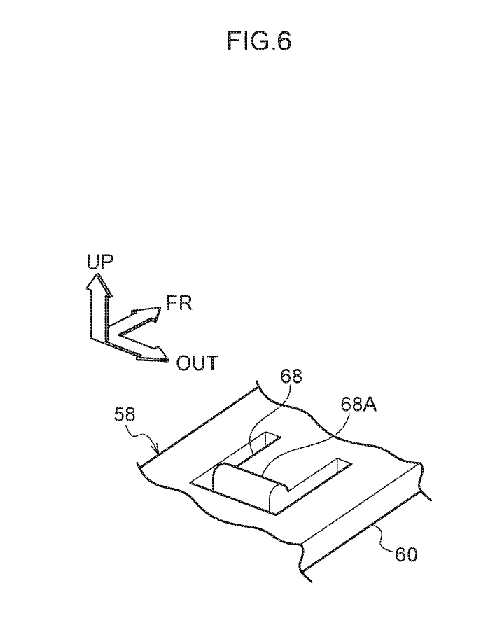

The insertion plate 60 is formed with an anchor claw 68 (see FIG. 6), serving as an anchor means, at the vehicle rear side of the graphic film 66. A vehicle front side end (base end) of the anchor claw 68 is integrated to the insertion plate 60. A vehicle rear side end portion (leading end portion) of the anchor claw 68 is formed with a substantially semicircular column shaped anchor projection 68A. The anchor projection 68A protrudes out toward the upper side (or the lower side), and is curved such that an outer peripheral face thereof has a convex profile. When inserting the insertion plate 60 into the housing 24 via the communication hole 26 in the housing 24, the anchor projection 68A abuts a peripheral face of the communication hole 26, such that a portion of the anchor claw 68 other than a vehicle rear side end portion (including the anchor projection 68A) elastically deforms, and the anchor projection 68A passes through the communication hole 26. Accordingly, when inserting the insertion plate 60 into the housing 24, the portion of the anchor claw 68 other than the vehicle rear side end portion elastically recovers, such that the anchor projection 68A engages with a vehicle front side face of the vehicle rear side wall of the housing 24. The film body 58 is thereby anchored in the housing 24, restricting removal of the film body 58 from the housing 24 and the case 32.

A vehicle front side face of the grip portion 62 is integrally formed with a seal 70 that has a triangular cross-section profile and that serves as a restriction means. The seal 70 is disposed around the entire periphery of the insertion plate 60. The seal 70 is elastic and has sealing properties, and the seal 70 is elastically compressed due to being squeezed between the grip portion 62 and the vehicle rear side wall of the housing 24, thereby forming a seal between the grip portion 62 and the vehicle rear side wall of the housing 24. This thereby restricts the incursion of water into the housing 24 from the exterior of the housing 24 via the communication hole 26.

Next, explanation follows regarding operation of the present exemplary embodiment.

In the vehicle projection device 10 of the vehicle door mirror device 12 configured as described above, electric power from the power source is supplied to the LED 42 via the cords 54, the connector 52, and the circuit board 40, and the LED 42 radiates light toward the lower side such that the light passes through (travels through) the collimator lens 44, the graphic film 66 and the transmitting hole 64 of the film body 58, the first image-forming lens 46, the second image-forming lens 50 (exposure hole 36 in the case 32), and the outer lens 30 (through hole 20 in the visor 16). The graphic 66A of the graphic film 66 is projected (beamed) onto the ground at the outer side of the vehicle.

Note that when the mirror 22 has been detached from the attachment mechanism inside the visor 16, thus opening up the inside of the visor 16 to the vehicle rear side via the opening 18, the grip portion 62 of the film body 58 is exposed to the vehicle rear side via the opening 18. Accordingly, by gripping the grip portion 62, it is possible to detach the film body 58 toward the exterior of the housing 24, via the communication hole 26 in the housing 24 and the opening 34 in the case 32. This thereby enables the film body 58 to be detached toward the exterior of the housing 24. Accordingly, the graphic film 66 inserted into the gap 48 inside the case 32 via the opening 34 can be changed by swapping the film body 58 (or just the graphic film 66) for insertion into the housing 24 via the communication hole 26, thereby enabling the graphic 66A projected onto the ground at the outer side of the vehicle to be changed.

Moreover, the seal 70 of the film body 58 forms a seal between the grip portion 62 and the vehicle rear side wall of the housing 24. This thereby restricts the incursion of water into the housing 24 from the exterior of the housing 24 via the communication hole 26. This thereby enables the incursion of water into the housing 24 via the communication hole 26 to be suppressed.

Furthermore, the film body 58 is anchored to the housing 24 by engaging the anchor projection 68A of the anchor claw 68 of the film body 58 with the vehicle front side face of the vehicle rear side wall of the housing 24, thus restricting removal of the film body 58 from the housing 24 and the case 32. This thereby enables unintended removal of the film body 58 from the housing 24 and the case 32 to be suppressed.

Moreover, when detaching the film body 58 toward the exterior of the housing 24 via the communication hole 26 in the housing 24, abutting the anchor projection 68A of the anchor claw 68 against the peripheral face of the communication hole 26 elastically deforms the portion of the anchor claw 68 other than the vehicle rear side end portion (including the anchor projection 68A), such that the anchor projection 68A passes through the communication hole 26. Accordingly, the anchor claw 68 can be suppressed from hindering detachment of the film body 58 toward the exterior of the housing 24.

### First Modified Example

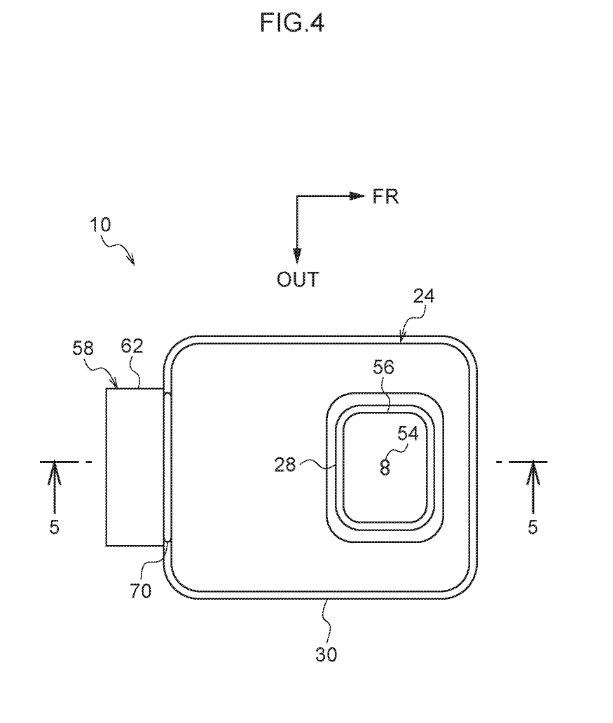

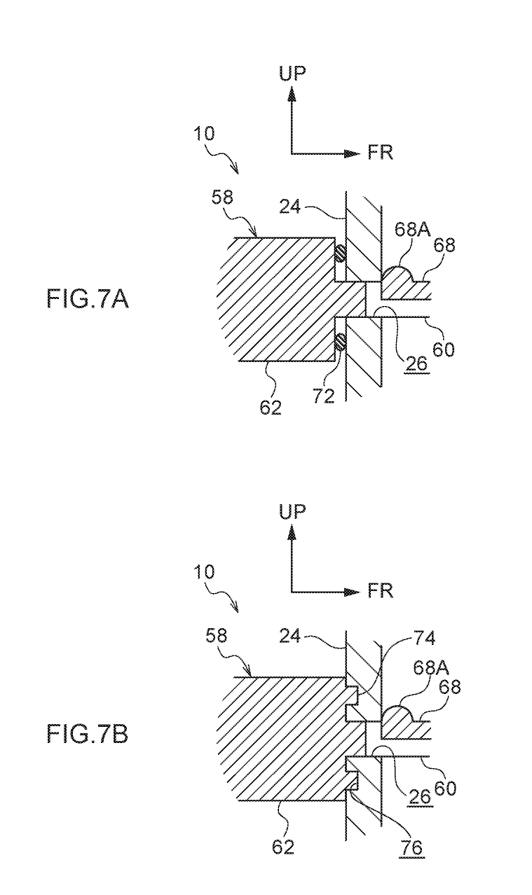

FIG. 7A is a cross-section (a cross-section taken at the position of line 5-5 in FIG. 4) illustrating relevant portions of a first modified example of the vehicle projection device 10 according to the present exemplary embodiment, as viewed from the right of the vehicle.

As illustrated in FIG. 7A, in the present modified example, a rectangular shaped ring 72, serving as a restriction means, is squeezed between the grip portion 62 of the film body 58 and the vehicle rear side wall of the housing 24. The ring 72 is disposed around the entire periphery of the insertion plate 60 of the film body 58. The ring 72 is elastic and has sealing properties. The ring 72 is elastically compressed so as to form a seal between the grip portion 62 and the vehicle rear side wall of the housing 24, thereby restricting the incursion of water into the housing 24 from the exterior of the housing 24 via the communication hole 26.

### Second Modified Example

FIG. 7B is a cross-section (a cross-section taken at the position of line 5-5 in FIG. 4) illustrating relevant portions of a second modified example of the vehicle projection device 10 according to the present exemplary embodiment, as viewed from the right of the vehicle.

As illustrated in FIG. 7B, in the present modified example, a protrusion 74 that has a rectangular shape as viewed face-on and that configures a restriction means is formed on a vehicle front side face of the grip portion 62 of the film body 58. The protrusion 74 is configured with a rectangular cross-section profile, and is disposed around the entire periphery of the insertion plate 60 of the film body 58.

A recess 76 that has a rectangular shape as viewed face-on and that configures the restriction means is formed in a vehicle rear side face of the vehicle rear side wall of the housing 24. The recess 76 has a rectangular cross-section profile, and is disposed around the entire periphery of the communication hole 26 of the housing 24.

The protrusion 74 is inserted into (fitted into) the recess 76. An incursion route of water into the communication hole 26 from the exterior of the housing 24 is lengthened by the recess 76 and the protrusion 74, thereby restricting the incursion of water into the housing 24 from the exterior of the housing 24 via the communication hole 26.

Note that in the present modified example, the protrusion 74 is formed on the vehicle front side face of the grip portion 62 of the film body 58, and the recess 76 is formed in the vehicle rear side face of the vehicle rear side wall of the housing 24. However, configuration may be made in which the recess 76 is formed in the vehicle front side face of the grip portion 62 of the film body 58, and the protrusion 74 is formed on the vehicle rear side face of the vehicle rear side wall of the housing 24.

### Second Exemplary Embodiment

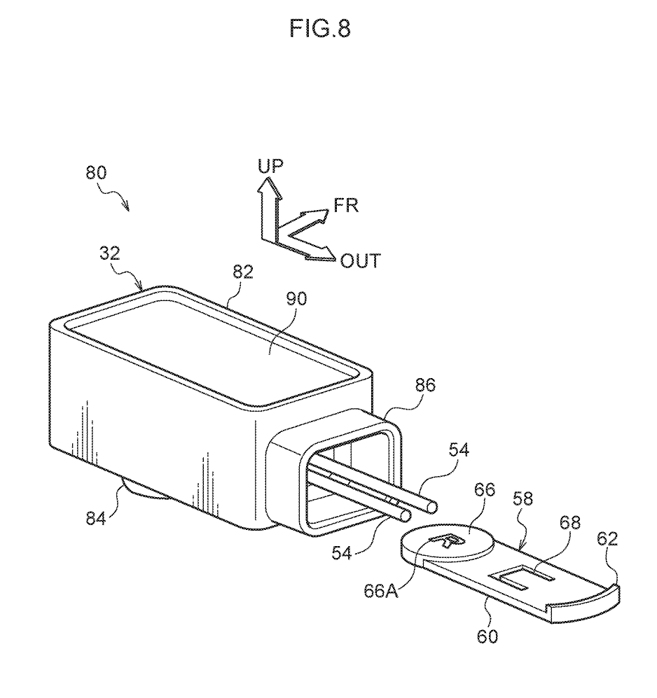

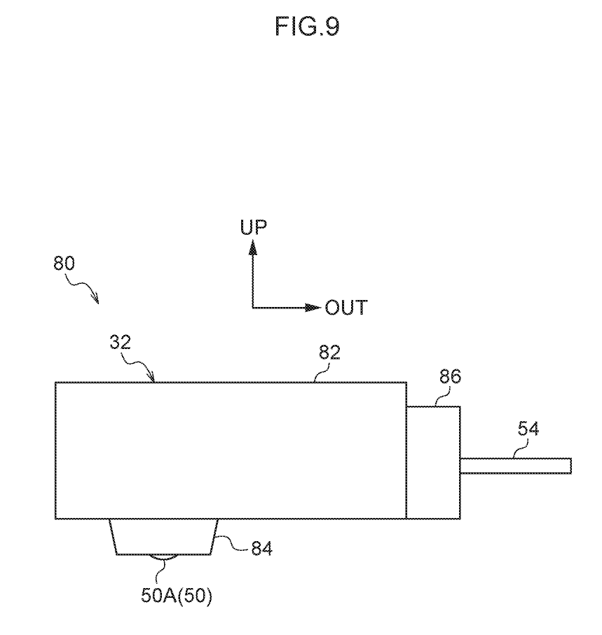

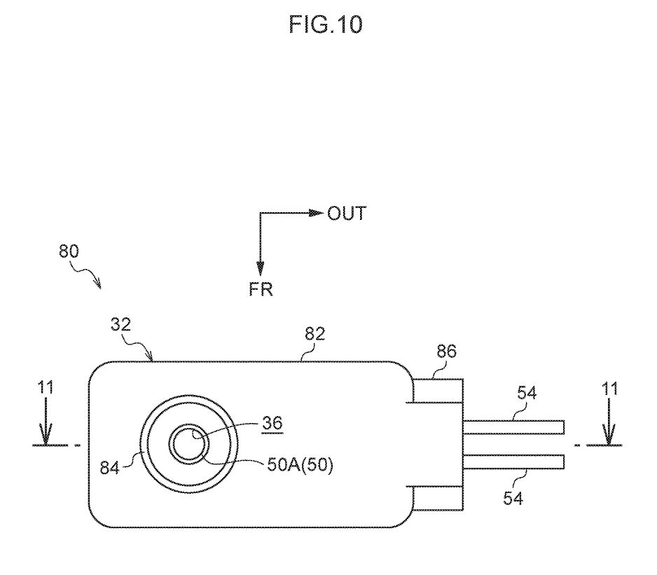

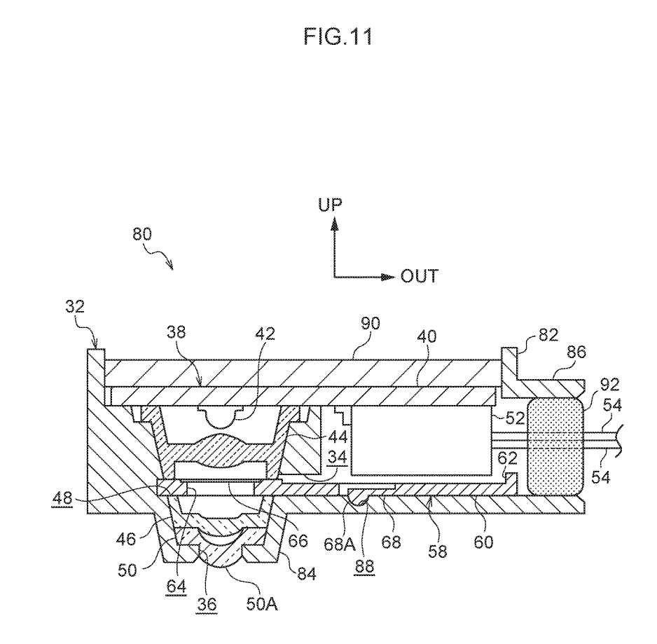

FIG. 8 is a perspective view illustrating a vehicle projection device 80 according to a second exemplary embodiment of the present invention, as viewed diagonally from the rear right of the vehicle. FIG. 9 is a face-on view illustrating the vehicle projection device 80 as viewed from the rear of the vehicle. FIG. 10 is a bottom view illustrating the vehicle projection device 80 as viewed from below. FIG. 11 is a cross-section (a cross-section taken along line 11-11 in FIG. 10) illustrating the vehicle projection device 80 as viewed from the front of the vehicle.

The vehicle projection device 80 according to the present exemplary embodiment has substantially the same configuration as that of the first exemplary embodiment described above, but differs in the following respects.

As illustrated in FIG. 8 to FIG. 11, the vehicle projection device 80 according to the present exemplary embodiment is not provided with the housing 24, the outer lens 30, or the grommet 56 of the first exemplary embodiment, and the case 32 functions as a housing body. The case 32 is fixed inside the visor 16, thereby fixing the vehicle projection device 80 inside the visor 16.

The case 32 is provided with a rectangular box-shaped housing box 82, serving as a housing section. The case 32 is configured such that the housing box 82 is integrally provided at an outer periphery of a case body 84 configuring the case 32 of the first exemplary embodiment described above, at a portion of the case body 84 excluding a lower end portion of the case body 84. An outer side of a vehicle right side wall of the housing box 82 is integrally formed with a rectangular tube shaped connection tube 86, serving as a detachment section. The interior of the connection tube 86 is in communication with the interior of the housing box 82, and a lower face of the interior of the connection tube 86 is set flush with a lower face of the interior of the housing box 82. The lower face of the interior of the housing box 82 is formed with an anchor recess 88 having a semicircular cross-section profile. A peripheral face of the anchor recess 88 is curved with a recessed profile.

The lower end portion of the case body 84 is disposed inside the circular through hole 20 in the visor 16. The lower end portion of the case body 84 and the second image-forming lens 50 close off the through hole 20. A seal is formed between the case body 84 and the second image-forming lens 50, thereby restricting the incursion of water into the case 32 from between the case body 84 and the second image-forming lens 50.

The opening 34 in the case 32 is formed at a vehicle right side portion of a peripheral wall of the case body 84. The opening 34 faces the interior of the connection tube 86 of the housing box 82 along the vehicle width direction.

The housing box 82 is open at an upper face, and the circuit board 40 is housed inside the housing box 82 at an upper side of the case body 84. A rectangular block shaped heat dissipating block 90, serving as a heat dissipating member, is disposed inside the opening in the upper face of the housing box 82. The heat dissipating block 90 is placed at the upper side of the circuit board 40. A seal is formed between the housing box 82 and the heat dissipating block 90, for example by what is known as “potting”, thereby restricting the incursion of water into the case 32 from between the housing box 82 and the heat dissipating block 90. The heat dissipating block 90 is, for example, made from aluminum, and has high thermal conductivity. The heat dissipating block 90 transmits heat generated by the circuit board 40 and the LED 42 such that the heat is released toward the exterior of the case 32 during light emission from the LED 42.

The connection tube 86 of the housing box 82 is disposed at the lower side of the circuit board 40, and the connector 52 is housed inside the housing box 82 via the interior of the connection tube 86, and is attached to the lower side of the circuit board 40. Moreover, the cords 54 are laid out toward the exterior of the case 32 via the interior of the connection tube 86.

A grommet 92, serving as a restriction means (sealing member), is fitted into the connection tube 86 of the housing box 82. The cords 54 pass through the grommet 92. The grommet 92 is elastic and has sealing properties, and the grommet 92 is elastically compressed so as to form a seal inside the connection tube 86. This thereby restricts the incursion of water into the case 32 from the exterior of the case 32 via the interior of the connection tube 86.

The film body 58 is integrally formed with a grip portion 62 at a vehicle right side end of the insertion plate 60. The grip portion 62 projects out toward the upper side. The film body 58 is inserted into the case 32 via the interior of the connection tube 86 of the housing box 82, such that the insertion plate 60 is disposed at the lower side of the connector 52. The grip portion 62 is disposed at the vehicle right side of the connector 52. The insertion plate 60 is fitted into the gap 48 inside the case body 84 via the opening 34 in the case body 84, and the transmitting hole 64 and the graphic film 66 are provided at a vehicle left side portion of the insertion plate 60.

The anchor claw 68 of the insertion plate 60 is formed on the vehicle right side of the graphic film 66, and a vehicle right side end (base end) of the anchor claw 68 is integrated to the insertion plate 60. The anchor projection 68A of the anchor claw 68 is formed at a vehicle left side end portion (leading end portion) of the anchor claw 68, and the anchor projection 68A projects out toward the lower side. When inserting the film body 58 into the case 32 via the interior of the connection tube 86 of the housing box 82, the anchor projection 68A abuts the lower face of the interior of the connection tube 86 and the lower face of the interior of the housing box 82, such that a portion of the anchor claw 68 other than the vehicle left side end portion (including the anchor projection 68A) elastically deforms, and the anchor projection 68A is inserted into the housing box 82 via the interior of the connection tube 86. Accordingly, when the film body 58 has been inserted into the case 32, the portion of the anchor claw 68 other than the vehicle left side end portion elastically recovers, and the anchor projection 68A engages (fits together with) the anchor recess 88 in the housing box 82. The film body 58 is thus anchored to the case 32, restricting removal of the film body 58 from the case 32.

Next, explanation follows regarding operation of the present exemplary embodiment.

In the vehicle projection device 80 of the vehicle door mirror device 12 configured as described above, electric power from the power source is supplied to the LED 42 via the cords 54, the connector 52, and the circuit board 40, and the LED 42 radiates light toward the lower side such that the light passes through (travels through) the collimator lens 44, the graphic film 66 and the transmitting hole 64 of the film body 58, the first image-forming lens 46, and the second image-forming lens 50 (the exposure hole 36 in the case 32 and the through hole 20 in the visor 16). The graphic 66A of the graphic film 66 is projected (beamed) onto the ground at the outer side of the vehicle.

Note that when the mirror 22 has been detached from the attachment mechanism inside the visor 16, thus opening up the inside of the visor 16 to the vehicle rear side via the opening 18, the connection tube 86 of the case 32 is exposed to the vehicle rear side via the opening 18. Accordingly, by detaching the grommet 92 from the interior of the connection tube 86 and gripping the grip portion 62 of the film body 58 inside the housing box 82 of the case 32 via the interior of the connection tube 86, it is possible to detach the film body 58 toward the exterior of the case 32, via the interior of the connection tube 86. This thereby enables the film body 58 to be detached toward the exterior of the case 32. Accordingly, the graphic film 66 inserted into the gap 48 inside the case body 84 via the opening 34 can be changed by swapping the film body 58 (or just the graphic film 66) for insertion into the case 32 via the interior of the connection tube 86, thereby enabling the graphic 66A projected onto the ground at the outer side of the vehicle to be changed.

Moreover, the grommet 92 forms a seal inside the connection tube 86. This thereby restricts the incursion of water into the case 32 from the exterior of the case 32 via the interior of the connection tube 86. This thereby enables the incursion of water into the case 32 via the interior of the connection tube 86 to be suppressed.

Moreover, the grommet 92 not only restricts the incursion of water to the location of the film body 58 inside the case 32, but also restricts the incursion of water to the location of the connector 52 inside the case 32. Accordingly, the incursion of water into the case 32 can be restricted by a simple configuration.

Moreover, the film body 58 is anchored to the case 32 by engaging the anchor projection 68A of the anchor claw 68 of the film body 58 with the anchor recess 88 in the case 32, thereby restricting removal of the film body 58 from the case 32. This thereby enables unintentional removal of the film body 58 from the case 32 to be suppressed.

Moreover, when detaching the film body 58 toward the exterior of the case 32 via the interior of the connection tube 86 of the case 32, abutting the anchor projection 68A of the anchor claw 68 against the lower face of the interior of the housing box 82 and the lower face of the interior of the connection tube 86 elastically deforms the portion of the anchor claw 68 other than the vehicle left side end portion (including the anchor projection 68A), such that the anchor projection 68A passes through the interior of the housing box 82 and the interior of the connection tube 86. Accordingly, the anchor claw 68 can be suppressed from hindering detachment of the film body 58 toward the exterior of the case 32.

Moreover, the connection tube 86 of the case 32 is disposed at the lower side of the circuit board 40, and the connector 52 is disposed inside the case 32 via the interior of the connection tube 86 and is disposed at the lower side of the circuit board 40. Accordingly, the size of the vehicle projection device 80 at the upper side of the circuit board 40 can be reduced, unlike in cases in which the connector 52 is disposed at the upper side of the circuit board 40. Moreover, the volume of the heat dissipating block 90 at the upper side of the circuit board 40 can be made larger, thereby enabling heat generated by the circuit board 40 and the LED 42 when the LED 42 is radiating light to be effectively transmitted to the heat dissipating block 90, and thus enabling the heat to be effectively released toward the exterior of the case 32.

Note that in the first exemplary embodiment and the second exemplary embodiment described above, the vehicle projection device 10, 80 is installed to the vehicle door mirror device 12. However, it is sufficient that the vehicle projection device 10, 80 be capable of projecting the graphic 66A toward the outer side of the vehicle. For example, the vehicle projection device 10, 80 may be installed to a vehicle door (including a door handle). The vehicle projection device 10, 80 may even be installed at a location on the vehicle cabin side of a door, as long as the vehicle projection device 10, 80 is capable of projecting the graphic 66A toward the outer side of the vehicle when the door has been opened.

The disclosure of Japanese Patent Application No. 2015-8820, filed on Jan. 20, 2015, is incorporated in its entirety by reference herein.

### EXPLANATION OF THE REFERENCE NUMERALS

10 vehicle projection device
24 housing (housing body)
26 communication hole (detachment section)
32 case (housing body)
38 projection mechanism (projection means)
40 circuit board (supply body)
52 connector
58 film body (image member)
66A graphic (image)
68 anchor claw (anchor means)
70 seal (restriction means)
72 ring (restriction means)
74 protrusion (restriction means)
76 recess (restriction means)
80 vehicle projection device
86 connection tube (detachment section)
92 grommet (restriction means)

1-5. (canceled)

6. A vehicle projection device, comprising:
a housing body that is provided at a vehicle and that includes a detachment section;
an image member that is disposed inside the housing body, that includes an insertion plate and a film, the film including an image, and that is capable of being detached toward an exterior of the housing body via the detachment section;
a projection means that projects the image toward an outer side of the housing body; and
an anchor means that is provided at the insertion plate, and that anchors the image member inside the housing body.

7. The vehicle projection device of claim 6, further comprising a restriction means that restricts incursion of water into the housing body via the detachment section.

8. The vehicle projection device of claim 7, further comprising:
a supply body that configures the projection means and that is disposed such that the detachment section is on one side of the supply body; and
a connector that is disposed inside the housing body via the detachment section, that is disposed on the one side of the supply body, that is connected to the supply body, and that supplies electric power to the supply body.

9. The vehicle projection device of claim 8, further comprising a heat dissipating member that is disposed on another side of the supply body, and that transmits and releases heat generated by the supply body.
